(19) United States
(12) Patent Application Publication
(10) Pub. No.: US 2010/0138781 A1
(43) Pub. Date: Jun. 3, 2010

(54) PHONEBOOK ARRANGEMENT

(75) Inventors: Panu Korhonen, Helsinki (FI); Akseli Anttila, Helsinki (FI); Edwin Shannon, London (GB); Tom Jenkins, London (GB)

Correspondence Address: Perman & Green, LLP, 99 Hawley Lane, Stratford, CT, 06614, US

(73) Assignee: NOKIA CORPORATION, Espoo (FI)

(21) Appl. No.: 12/325,212

(22) Filed: Nov. 30, 2008

(51) Int. Cl. G06F 3/048

(52) U.S. Cl. 715/808; 715/841; 715/823; 715/833

(57) ABSTRACT

In a contacts application, detecting an activation of a selectable element in a current view of the application. If the selectable element is a title bar of the current view, determining if the activation is one of a first type or a second type. If the activation is of the first type, presenting a list of application specific options associated with the current view. If the selectable element is an item in the current view, determining if the activation is one of the first type or the second type. If the activation is of the second type, presenting a list of view specific options associated with the selected item.

### CROSS-REFERENCE TO RELATED APPLICATIONS

This application is related to U.S. patent application Ser. No. ______, filed on 30 Nov. 2008, (Atty Docket No. 684-013661-US(PAR), Disclosure No. NC66440) entitled “ITEM AND VIEW SPECIFIC OPTIONS”, the disclosure of which is incorporated herein by reference in its entirety.

### BACKGROUND

1. Field

The aspects of the disclosed embodiments generally relate to user interfaces and more particularly to a user interface for a phonebook or contacts application.

2. Brief Description of Related Developments

Generally, phonebooks and contacts applications provide different functions and tools related to the different features of the application. Users can access different menu and selection commands that provide features generally related to operation of the application, such as for example creating a new contact entry, creating a group list or opening another or related application. Similarly, a user can access features related to a specific view or item of the application, such as for example, deleting, copying or editing an entry, sending a message, or opening a communication channel. However, it is not always straightforward to know what the available or associated features and functions are, and one or more menus may need to be navigated in order to access the available or corresponding features and functions.

It would be advantageous to be able have easy access to functions, both local and global, as well as data, related to an application or a particular application view. It was also be advantageous to be able to access and navigate the corresponding menus in a simple and intuitive manner.

### SUMMARY

The aspects of the disclosed embodiments are directed to a method, apparatus, user interface and computer program product. In one embodiment the method includes, in a contacts application, detecting an activation of a selectable element in a current view of the application. If the selectable element is a title bar of the current view, determining if the activation is one of a first type or a second type. If the activation is of the first type, presenting a list of application specific options associated with the current view. If the selectable element is an item in the current view, determining if the activation is one of the first type or the second type. If the activation is of the second type, presenting a list of view specific options associated with the selected item.

### BRIEF DESCRIPTION OF THE DRAWINGS

The foregoing aspects and other features of the embodiments are explained in the following description, taken in connection with the accompanying drawings, wherein:

FIG. 1 shows a block diagram of a system in which aspects of the disclosed embodiments may be applied;

FIG. 2 illustrates an exemplary process flow incorporating aspects of the disclosed embodiments;

FIGS. 3A-3B illustrate exemplary user interfaces including aspects of the disclosed embodiments;

FIGS. 4A and 4B are illustrations of exemplary devices that can be used to practice aspects of the disclosed embodiments;

FIG. 5 illustrates a block diagram of an exemplary system incorporating features that may be used to practice aspects of the disclosed embodiments; and

FIG. 6 is a block diagram illustrating the general architecture of an exemplary system in which the devices of FIGS. 4A and 4B may be used.

### DETAILED DESCRIPTION OF THE EMBODIMENT(S)

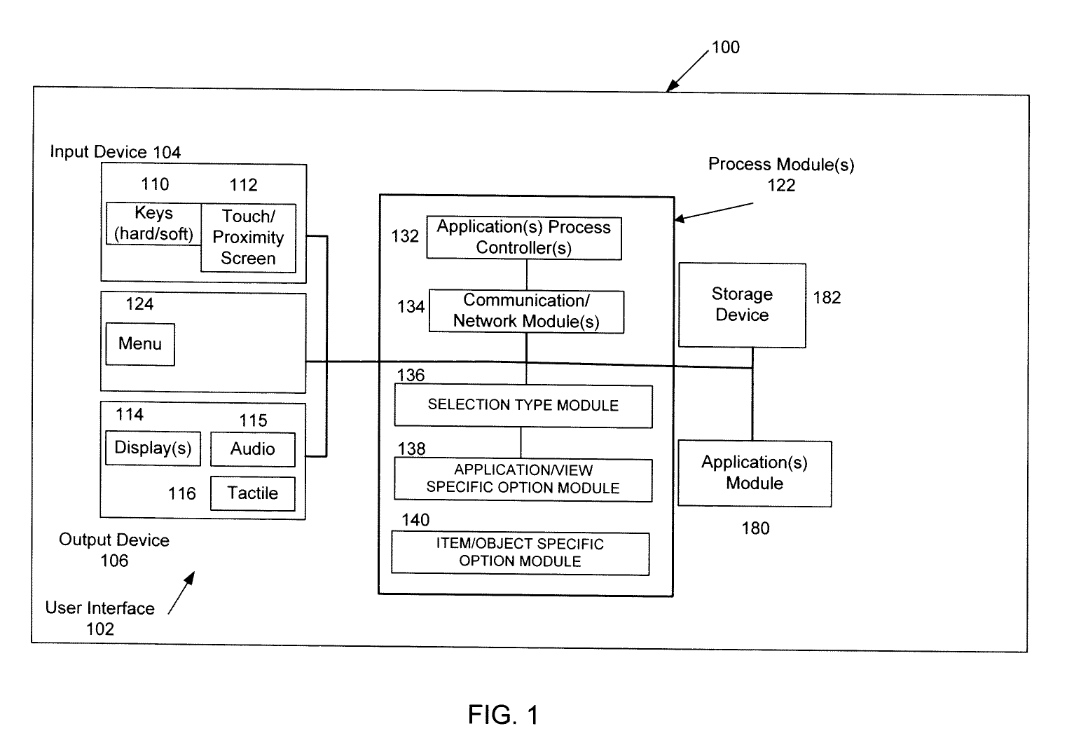

The aspects of the disclosed embodiments provide easy access to functions associated with an application, such as for example a phonebook or contacts application. FIG. 1 illustrates one embodiment of a system 100 in which aspects of the disclosed embodiments can be applied. Although the disclosed embodiments will be described with reference to the embodiments shown in the drawings and described below, it should be understood that these could be embodied in many alternate forms. In addition, any suitable size, shape or type of elements or materials could be used.

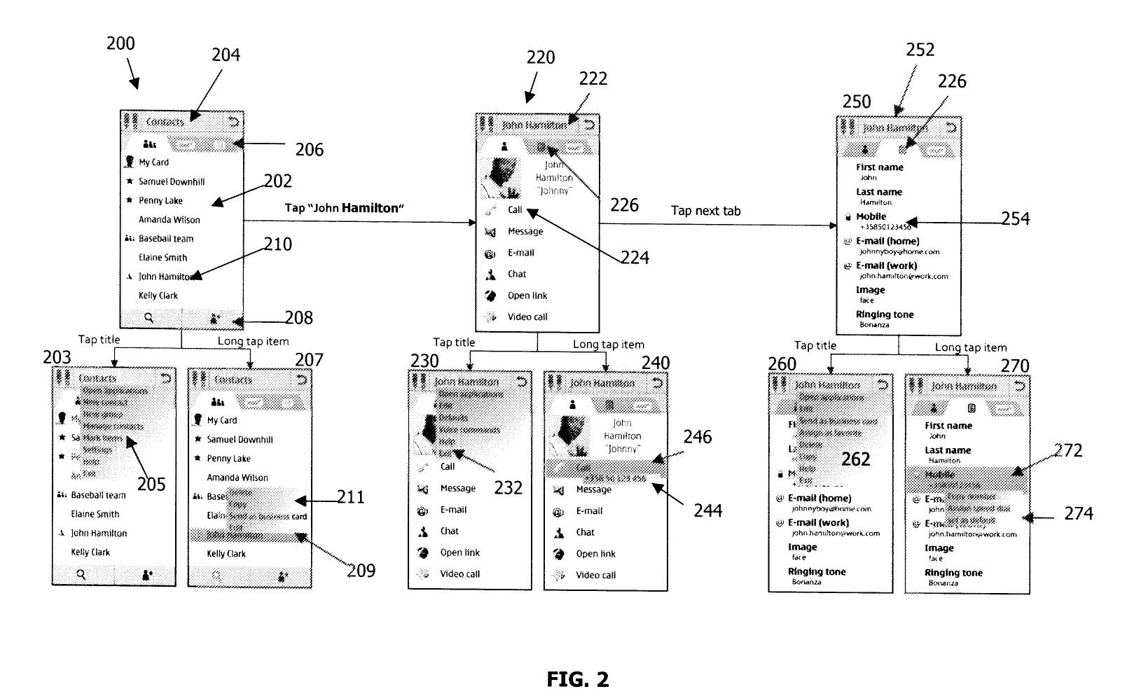

In a phonebook or contacts application, each view will generally include a title bar and a list of items associated with the view. One example of a phonebook or contacts application view is shown in FIG. 2. The screen view 200 includes a list 202 of contacts. In this example, the view 200 also includes title bar 204, function tabs 206 and tool tabs or toolbar 208. In alternate embodiments, the view 200 can include any suitable items, tools and navigation indicators.

The aspects of the disclosed embodiments allow a user to easily identify and access the different functions associated with the application or view by grouping the various functions related to the view and specific items. The respective menus are generated when a selectable element is activated. For example, referring to FIG. 2, in one embodiment, if an activation command, such as a short tap on the title bar 204 is detected, the menu 205 is generated, as shown in screen 203. In one embodiment, the menu 205 comprises a list of application related functions. Similarly, if a long tap is detected on item 210 “John Hamilton” in screen 200, the menu 211 is displayed. In one embodiment, the menu 211 comprises a list of view or item specific functions. By associating the various functions available in an application to certain selectable elements in a view, the functions can easily, quickly and intuitively be accessed.

FIG. 1 illustrates one example of a system 100 incorporating aspects of the disclosed embodiments. Generally, the system 100 includes a user interface 102, process modules 122, applications module 180, and storage devices 182. In alternate embodiments, the system 100 can include other suitable systems, devices and components that allow for associating option menus with a title bar and allows for easy and quick identification and selection of the option menus. The components described herein are merely exemplary and are not intended to encompass all components that can be included in the system 100. The system 100 can also include one or more processors or computer program products to execute the processes, methods, sequences, algorithms and instructions described herein.

In one embodiment, the process module 122 includes a selection module 136, an application/view specific options module 138 and an item or object specific option module 140. In alternate embodiments, the process module 122 can include any suitable option modules. The selection module 136 is generally configured to determine which selectable element in the application view is being selected, together with the activation type. In the example referred to above with respect to FIG. 2, the selection module 136 would detect that the title bar 204 is selected and would identify the activation type. If the activation type is a single tap, the request is forwarded to the application option module 140. Although the example here is described with reference to a single tap or long tap, in alternate embodiments the activation type can be any suitable input command. These can include, for example, a tap, a double tap or a tap and hold. In one embodiment, directional movements on or across the selected element can correspond to different command inputs. For example, a slide to the right can open one menu, while a slide to the left can open another menu. In one embodiment, different portions of the title bar 204 of FIG. 2 can be used to activate different option menus. For example, a tap or other command, on a right side of the title bar 204 can activate one menu, while a tap on the left side can activate another menu. In one embodiment, a middle portion of the title bar can be configured to activate another menu. Similarly, when using a cursor control device such as mouse, left and right clicks can be used to activate different menus

Based upon the received command, the selection module 136 can activate the application/view specific options module 138 or the item/object specific options module 140. The application/view specific options module 138 is generally configured to create and generate an options menu that includes functions that operate on the application and any cooperating application. For example, in a Contacts application, these applications might include “open application”, “create new”, “mark items”, “settings”, “help” and “exit.” The application/view specific options module 138 will group the available functions that operate on the application from current context menus and present the corresponding menu upon selection.

The item/object specific options module 140 is generally configured to group options that are related to a specific view or object. For example, in a Contacts application, options that correspond to a selected contact view or object, such as the item 210 for “John Hamilton” in FIG. 2, can include “Delete”, “Copy”, “Go to web address” or “Send business card”, to name a few. Upon detection of a corresponding command or selection input, the item/object specific options module 140 will group the available functions from current context menus and cause the corresponding item/object specific options menu to be generated. In one embodiment, the item/object specific options module 140 can provide a temporary focus, or other similar highlight or indication, on the affected object, as shown for example by item 209 in FIG. 2.

FIG. 2 illustrates one example of a process incorporating aspects of the disclosed embodiments. In this example, the view 200 includes a list 202 of contacts of a contact application. A first activation type, such as a single tap on the title bar 204 opens the application specific options menu 205 as shown in view 203. A second activation type, such as for example a long tap on the item 210 “John Hamilton”, opens the item specific options menu 211 in view 207. The aspects of the disclosed embodiments generally provide for associating one or more options menu with a title bar of an application screen view as well as selectable items within the view. Activation of the title bar opens an application or view specific options menu. Selection of an item in the view, depending upon the type of activation or selection command can open an item or object specific options menu.

In one embodiment, a single tap on item 210 can result in view 220, which in this example includes the contact details for “John Hamilton.” In view 220, a single tap on the title bar 222 opens the application specific options menu 232 in the view 230. These are general options that are related to the application specific view 230. A long tap on the item 224 “Call” in view 220 opens the options menu 244, which in this example presents a phone number. As shown in view 240, the selected item 244 is highlighted.

The function tabs 206 in view 200 can also be selected. The view 250 corresponds to a selection of the tab 226 in view 220. The view 250 presents the contact details for the selected contact 210 “John Hamilton.” A tap on the title bar 252 in view 250 opens the application/view specific options menu 262 shown in view 260. A long tap on the item 254 “Mobile” will open the item/object specific options menu 274 shown in view 270. As seen in view 270, the selected item/object 272 is highlighted.

In this example, it is demonstrated that each item that is selectable can have an alternative representation. As the user navigates through the different layers of an application, for example from the list of contacts 202 to a specific contact 210 in screen 220, the associated application functions and item specific functions are regrouped. Further options are provided on a more local level and functions are grouped by their locality.

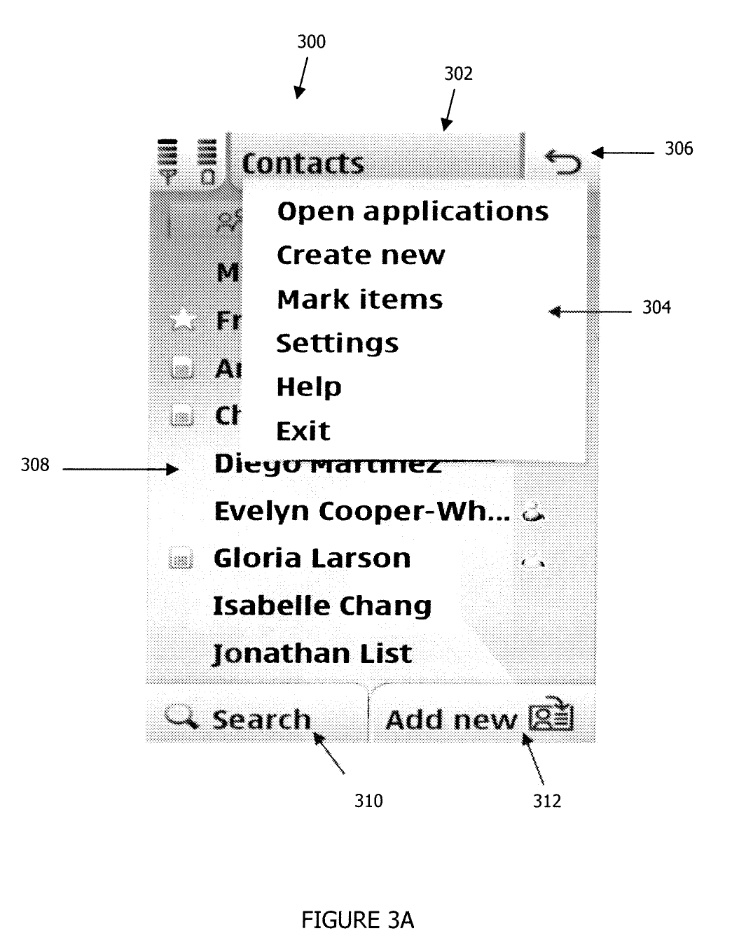

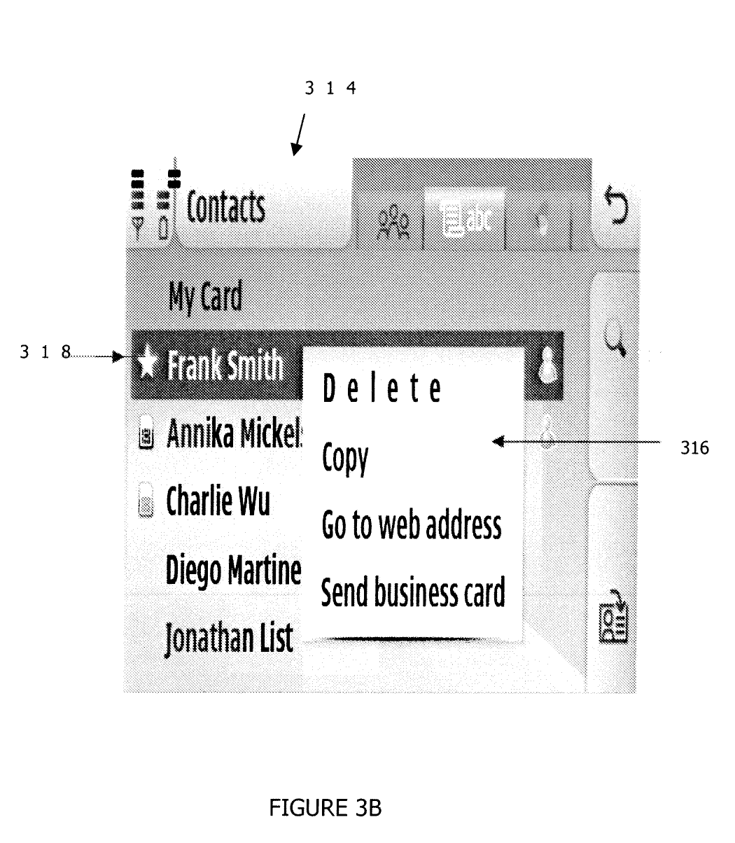

FIG. 3A-3B illustrate screen shots of exemplary user interfaces incorporating aspects of the disclosed embodiments. As shown in FIG. 3A, a screen or pane view 300 for an application item includes the title bar 302, an options menu 304, and a back or exit selector 306. In alternate embodiments other elements can be included in the view 300. In this particular example, the screen view 300 is for a Contacts application and includes a list 308 of contacts. The view 300 also includes function or tool tabs for Search 310 and Add new 312. In alternate embodiments any suitable tool or application specific elements can be included in the view 300.

The options menu 304 shown in FIG. 3A, is opened by selection or activation of the title bar 302. In this example, the options menu 304 shown in FIG. 3A includes functions or tools that are associated with the application identified in the title bar 302. In one embodiment, the options menu 304 comprises a pop-up window or menu. In alternate embodiments, the options menu 304 can be presented in any suitable manner on a display of a device. It is a feature of the disclosed embodiments to quickly, easily and intuitively inform a user of functions that are available in the current view and allow selection of any one of the functions in a quick and straightforward manner.

Referring to FIG. 3A, to open or access the menu 304, the user activates or selects the title bar 302 in any suitable manner. This can include for example, a tap, a double tap, or a tap and hold. In alternate embodiments any suitable icon or object selection method can be used. The menu 304 that includes the available functions will be displayed. A selection can be made from any one of the functions presented in the menu 304.

In one embodiment, one or more menus can be associated an application item, such as the title bar 302. For example, one menu could comprise functions associated with the application item while another menu could comprise data associated with the application item. In one embodiment, a first menu could include application and/or view specific options or functions, while the second menu can include item and/or object specific functions. FIG. 3A illustrates an example where the options menu 304 includes view specific options for the contacts application, such as “open application” or “add a new contact.” FIG. 3B illustrates an example of item or object specific options menu 316. Here, the menu 316 only includes options related to the selected contact 318, such as “Delete” or “Copy.” In alternate embodiments, any suitable number of menus and menu types can be associated with an application item. For example, different application items, options, functions, services or data can be grouped into different menus. Each menu can be presented upon a suitable activation. To access the different menus, different activation types can be used. For example, to access one menu, a single tap activation can be used. To access the other menu, a double tap activation or a tap and hold can be used. In another embodiment, a slide motion can be used to access a menu so that detection of a sliding motion in one direction opens one menu, while a slide motion in an opposite direction will open another menu. In an embodiment that includes more than two menus, the number of taps can be used to determine which menu will open.

Referring to FIG. 1, the input device(s) 104 are generally configured to allow a user to input data, instructions and commands to the system 100. In one embodiment, the input device 104 can be configured to receive input commands remotely or from another device that is not local to the system 100. The input device 104 can include devices such as, for example, keys 110, touch screen 112 and menu 124. The input devices 104 could also include a camera device (not shown) or other such other image capturing system. In alternate embodiments the input device can comprise any suitable device(s) or means that allows or provides for the input and capture of data, information and/or instructions to a device, as described herein.

The output device(s) 106 are configured to allow information and data to be presented to the user via the user interface 102 of the system 100 and can include one or more devices such as, for example, a display 114, audio device 115 or tactile output device 116. In one embodiment, the output device 106 can be configured to transmit output information to another device, which can be remote from the system 100. While the input device 104 and output device 106 are shown as separate devices, in one embodiment, the input device 104 and output device 106 can be combined into a single device, and be part of and form, the user interface 102. The user interface 102 can be used to receive and display information pertaining to content, objects and targets, as will be described below. While certain devices are shown in FIG. 1, the scope of the disclosed embodiments is not limited by any one or more of these devices, and an exemplary embodiment can include, or exclude, one or more devices.

The process module 122 is generally configured to execute the processes and methods of the disclosed embodiments. The application process controller 132 can be configured to interface with the applications module 180, for example, and execute applications processes with respects to the other modules of the system 100. In one embodiment the applications module 180 is configured to interface with applications that are stored either locally to or remote from the system 100 and/or web-based applications. The applications module 180 can include any one of a variety of applications that may be installed, configured or accessible by the system 100, such as for example, office, business, media players and multimedia applications, web browsers and maps. In alternate embodiments, the applications module 180 can include any suitable application. The communication module 134 shown in FIG. 1 is generally configured to allow the device to receive and send communications and messages, such as text messages, chat messages, multimedia messages, video and email, for example. The communications module 134 is also configured to receive information, data and communications from other devices and systems.

In one embodiment, the applications module can also include a voice recognition system that includes a text-to-speech module that allows the user to receive and input voice commands, prompts and instructions, through a suitable audio input device.

The user interface 102 of FIG. 1 can also include menu systems 124 coupled to the processing module 122 for allowing user input and commands. The processing module 122 provides for the control of certain processes of the system 100 including, but not limited to the controls for selecting files and objects, accessing and opening forms, and entering and viewing data in the forms in accordance with the disclosed embodiments. The menu system 124 can provide for the selection of different tools and application options related to the applications or programs running on the system 100 in accordance with the disclosed embodiments. In the embodiments disclosed herein, the process module 122 receives certain inputs, such as for example, signals, transmissions, instructions or commands related to the functions of the system 100, such as messages, notifications and state change requests. Depending on the inputs, the process module 122 interprets the commands and directs the process control 132 to execute the commands accordingly in conjunction with the other modules.

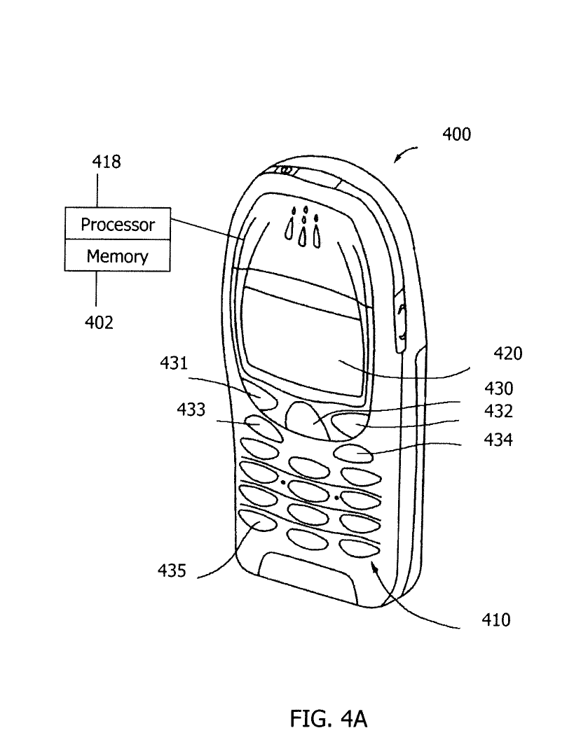

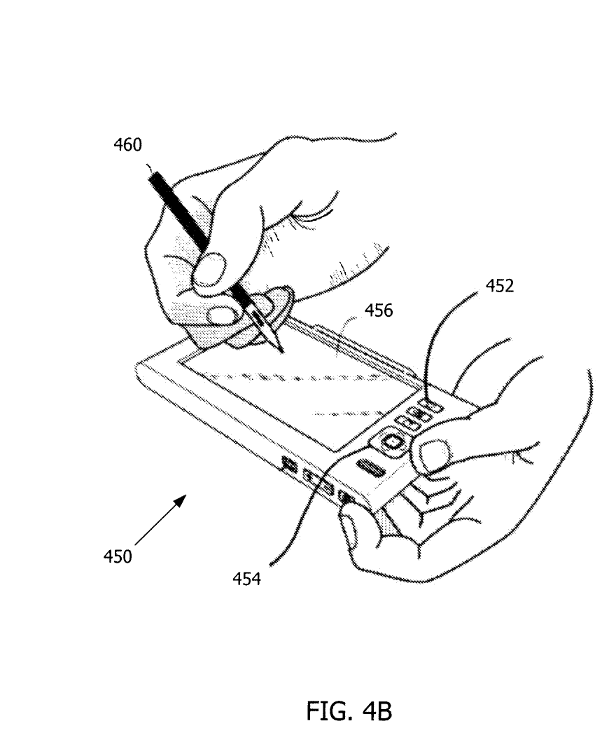

Referring to FIGS. 1 and 4B, in one embodiment, the user interface of the disclosed embodiments can be implemented on or in a device that includes a touch screen display, proximity screen device or other graphical user interface.

In one embodiment, the display 114 can be integral to the system 100. In alternate embodiments the display may be a peripheral display connected or coupled to the system 100. A pointing device, such as for example, a stylus, pen or simply the user's finger may be used with the display 114. In alternate embodiments any suitable pointing device may be used. In other alternate embodiments, the display may be any suitable display, such as for example a flat display 114 that is typically made of a liquid crystal display (LCD) with optional back lighting, such as a thin film transistor (TFT) matrix capable of displaying color images.

The terms “select” and “touch” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to include that a user only needs to be within the proximity of the device to carry out the desired function.

Similarly, the scope of the intended devices is not limited to single touch or contact devices. Multi-touch devices, where contact by one or more fingers or other pointing devices can navigate on and about the screen, are also intended to be encompassed by the disclosed embodiments. Non-touch devices are also intended to be encompassed by the disclosed embodiments. Non-touch devices include, but are not limited to, devices without touch or proximity screens, where navigation on the display and menus of the various applications is performed through, for example, keys 110 of the system or through voice commands via voice recognition features of the system.

Some examples of devices on which aspects of the disclosed embodiments can be practiced are illustrated with respect to FIGS. 4A-4B. The devices are merely exemplary and are not intended to encompass all possible devices or all aspects of devices on which the disclosed embodiments can be practiced. The aspects of the disclosed embodiments can rely on very basic capabilities of devices and their user interface. Buttons or key inputs can be used for selecting the various selection criteria and links, and a scroll function can be used to move to and select item(s).

FIG. 4A illustrates one example of a device 400 that can be used to practice aspects of the disclosed embodiments. As shown in FIG. 4A, in one embodiment, the device 400 may have a keypad 410 as an input device and a display 420 for an output device. The keypad 410 may include any suitable user input devices such as, for example, a multi-function/scroll key 430, soft keys 431, 432, a call key 433, an end call key 434 and alphanumeric keys 435. In one embodiment, the device 400 can include an image capture device such as a camera (not shown) as a further input device. The display 420 may be any suitable display, such as for example, a touch screen display or graphical user interface. The display may be integral to the device 400 or the display may be a peripheral display connected or coupled to the device 400. A pointing device, such as for example, a stylus, pen or simply the user's finger may be used in conjunction with the display 420 for cursor movement, menu selection and other input and commands. In alternate embodiments any suitable pointing or touch device, or other navigation control may be used. In other alternate embodiments, the display may be a conventional display. The device 400 may also include other suitable features such as, for example a loud speaker, tactile feedback devices or connectivity port. The mobile communications device may have a processor 418 connected or coupled to the display for processing user inputs and displaying information on the display 420. A memory 402 may be connected to the processor 418 for storing any suitable information, data, settings and/or applications associated with the mobile communications device 400.

Although the above embodiments are described as being implemented on and with a mobile communication device, it will be understood that the disclosed embodiments can be practiced on any suitable device incorporating a processor, memory and supporting software or hardware. For example, the disclosed embodiments can be implemented on various types of music, gaming and multimedia devices. In one embodiment, the system 100 of FIG. 1 may be for example, a personal digital assistant (PDA) style device 450 illustrated in FIG. 4B. The personal digital assistant 450 may have a keypad 452, cursor control 454, a touch screen display 456, and a pointing device 460 for use on the touch screen display 456. In still other alternate embodiments, the device may be a personal computer, a tablet computer, touch pad device, Internet tablet, a laptop or desktop computer, a mobile terminal, a cellular/mobile phone, a multimedia device, a personal communicator, a television set top box, a digital video/versatile disk (DVD) or high definition player or any other suitable device capable of containing for example a display 114 shown in FIG. 1, and supported electronics such as the processor 418 and memory 402 of FIG. 4A. In one embodiment, these devices will be Internet enabled and include GPS and map capabilities and functions.

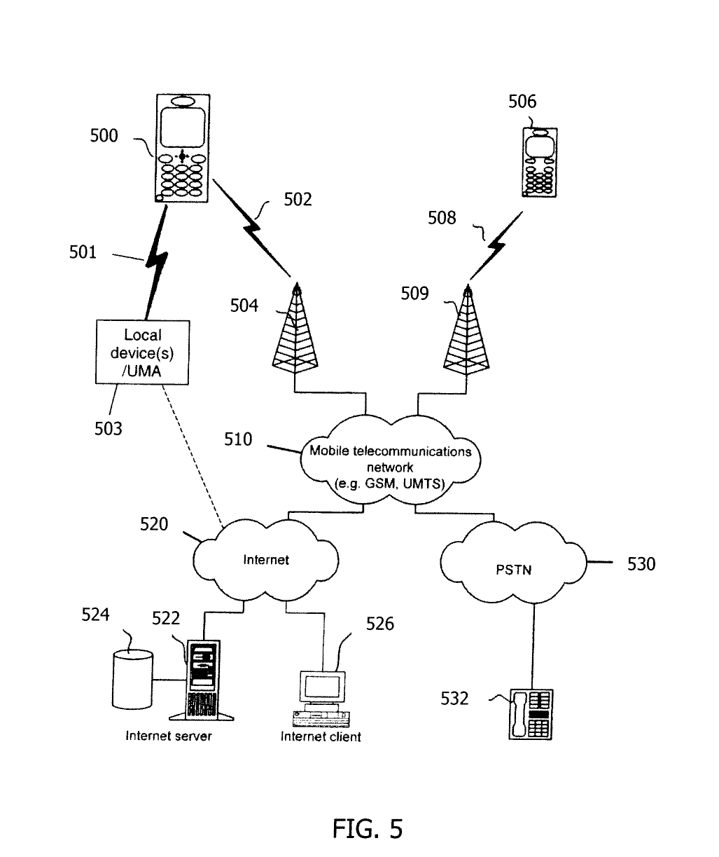

In the embodiment where the device 400 comprises a mobile communications device, the device can be adapted for communication in a telecommunication system, such as that shown in FIG. 5. In such a system, various telecommunications services such as cellular voice calls, worldwide web/wireless application protocol (www/wap) browsing, cellular video calls, data calls, facsimile transmissions, data transmissions, music transmissions, multimedia transmissions, still image transmission, video transmissions, electronic message transmissions and electronic commerce may be performed between the mobile terminal 500 and other devices, such as another mobile terminal 506, a line telephone 532, a personal computer (Internet client) 526 and/or an internet server 522.

It is to be noted that for different embodiments of the mobile device or terminal 500, and in different situations, some of the telecommunications services indicated above may or may not be available. The aspects of the disclosed embodiments are not limited to any particular set of services or communication, protocol or language in this respect.

The mobile terminals 500, 506 may be connected to a mobile telecommunications network 510 through radio frequency (RF) links 502, 508 via base stations 504, 509. The mobile telecommunications network 510 may be in compliance with any commercially available mobile telecommunications standard such as for example the global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 510 may be operatively connected to a wide-area network 520, which may be the Internet or a part thereof. An Internet server 522 has data storage 524 and is connected to the wide area network 520. The server 522 may host a worldwide web/wireless application protocol server capable of serving worldwide web/wireless application protocol content to the mobile terminal 500. The mobile terminal 500 can also be coupled to the Internet 520. In one embodiment, the mobile terminal 500 can be coupled to the Internet 520 via a wired or wireless link, such as a Universal Serial Bus (USB) or Bluetooth™ connection, for example.

A public switched telephone network (PSTN) 530 may be connected to the mobile telecommunications network 510 in a familiar manner. Various telephone terminals, including the stationary telephone 532, may be connected to the public switched telephone network 530.

The mobile terminal 500 is also capable of communicating locally via a local link 501 to one or more local devices 503. The local links 501 may be any suitable type of link or piconet with a limited range, such as for example Bluetooth™, a USB link, a wireless Universal Serial Bus (WUSB) link, an IEEE 802.11 wireless local area network (WLAN) link, an RS-232 serial link, etc. The local devices 503 can, for example, be various sensors that can communicate measurement values or other signals to the mobile terminal 500 over the local link 501. The above examples are not intended to be limiting, and any suitable type of link or short range communication protocol may be utilized. The local devices 503 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 500 may thus have multi-radio capability for connecting wirelessly using mobile communications network 510, wireless local area network or both. Communication with the mobile telecommunications network 510 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the navigation module 122 of FIG. 1 includes communication module 134 that is configured to interact with, and communicate with, the system described with respect to FIG. 5.

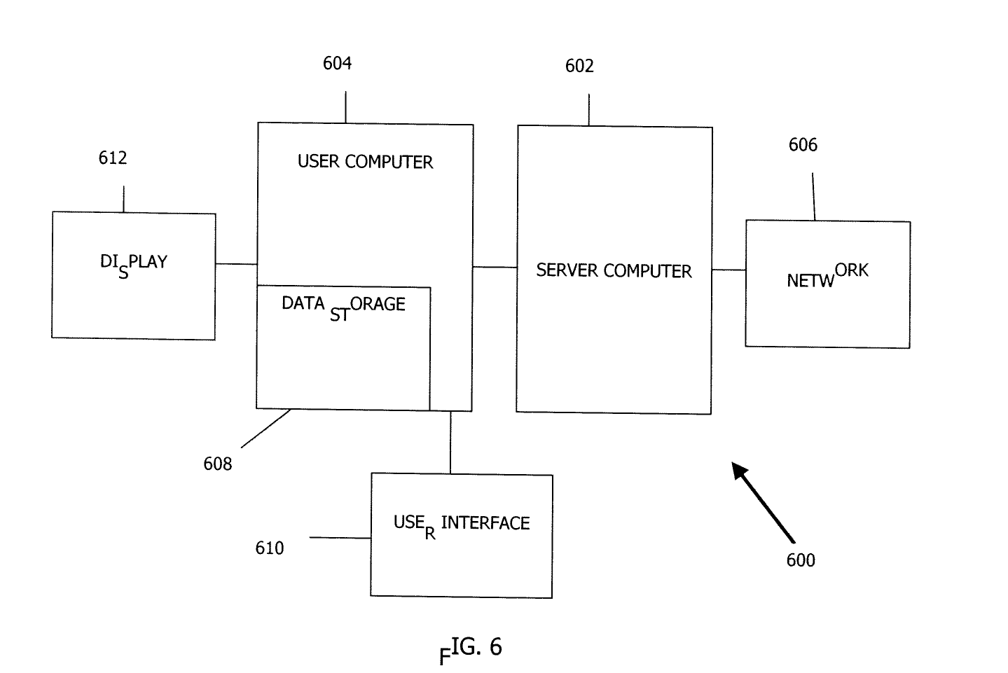

The disclosed embodiments may also include software and computer programs incorporating the process steps and instructions described above. In one embodiment, the programs incorporating the process steps described herein can be executed in one or more computers. FIG. 6 is a block diagram of one embodiment of a typical apparatus 600 incorporating features that may be used to practice aspects of the invention. The apparatus 600 can include computer readable program code means for carrying out and executing the process steps described herein. In one embodiment the computer readable program code is stored in a memory of the device. In alternate embodiments the computer readable program code can be stored in memory or memory medium that is external to, or remote from, the apparatus 600. The memory can be direct coupled or wireless coupled to the apparatus 600. As shown, a computer system 602 may be linked to another computer system 604, such that the computers 602 and 604 are capable of sending information to each other and receiving information from each other. In one embodiment, computer system 602 could include a server computer adapted to communicate with a network 606. Alternatively, where only one computer system is used, such as computer 604, computer 604 will be configured to communicate with and interact with the network 606. Computer systems 602 and 604 can be linked together in any conventional manner including, for example, a modem, wireless, hard wire connection, or fiber optic link. Generally, information can be made available to both computer systems 602 and 604 using a communication protocol typically sent over a communication channel or other suitable connection or line, communication channel or link. In one embodiment, the communication channel comprises a suitable broad-band communication channel. Computers 602 and 604 are generally adapted to utilize program storage devices embodying machine-readable program source code, which is adapted to cause the computers 602 and 604 to perform the method steps and processes disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read-only-memory (“ROM”) floppy disks and semiconductor materials and chips.

Computer systems 602 and 604 may also include a microprocessor for executing stored programs. Computer 602 may include a data storage device 608 on its program storage device for the storage of information and data. The computer program or software incorporating the processes and method steps incorporating aspects of the disclosed embodiments may be stored in one or more computers 602 and 604 on an otherwise conventional program storage device. In one embodiment, computers 602 and 604 may include a user interface 610, and/or a display interface 612 from which aspects of the invention can be accessed. The user interface 610 and the display interface 612, which in one embodiment can comprise a single interface, can be adapted to allow the input of queries and commands to the system, as well as present the results of the commands and queries, as described with reference to FIG. 1, for example.

The aspects of the disclosed embodiments provide for associating a title bar of an application view with one or more option menus. The functions that operate on an application or an associated view of an application can be grouped together. Depending upon a selection or activation criteria, the different option menus can be presented to the user.

It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A method comprising:
in a contacts application, detecting an activation of a selectable element in a current view of the application;
if the selectable element is a title bar of the current view, determining if the activation is one of a first type or a second type; and
if the activation is of the first type, presenting a list of application specific options associated with the current view;
if the selectable element is an item in the current view, determining if the activation is one of the first type or the second type; and
if the activation is of the second type, presenting a list of view specific options associated with the selected item.

2. The method of claim 1 further comprising that when the selectable element is the title bar, and the first activation type is a tap activation, the list of application specific options associated with the current view is generated.

3. The method of claim 1 further comprising that when the selectable element is an item corresponding to the current view, and the second activation type is a long tap on the item, the list of view specific options associated with the selected item is generated.

4. The method of claim 3, further comprising, after presenting the list of view specific options, highlighting the selected item in the current view.

5. The method of claim 1 wherein the list of application specific options and the list of view specific options is presented as a pop-up window.

6. The method of claim 1 wherein the activation of the first type is one of a tap, a long tap or a double tap, and the activation of the second type is different from the first type.

7. The method of claim 1 wherein the activation of the first type is a sliding motion in a first direction and the activation of the second type is a sliding motion in an opposite direction.

8. The method of claim 7, further comprising that when the selected element is the title bar, the activation of the first type generates the list of application specific options and the activation of the second type generates a data view corresponding to the current view.

9. The method of claim 1 further comprising that the selectable element is a title bar of the current view, and after determining that the activation is of the first type, determining functions that operate on an application corresponding to the application view, grouping the functions, and providing the group as the list of application specific options.

10. The method of claim 1, further comprising that the selectable element is an item corresponding to the current view, and after determining that the activation is of the first type, opening a next application view corresponding to the selected item.

11. The method of claim 9, further comprising, after determining that the activation is of the second type, determining functions that operate on the selected item, grouping the functions, and providing the group as the list of item specific options.

12. An apparatus comprising:
a processor configured to generate a view on a display from a contacts application, the view including at least a title bar and a selectable item;
a processor configured to detect a selection input of the title bar, and if the selection input is of a pre-determined type, generate a menu that includes functions that operate on contacts application related to the view; and
a processor configured to detect a selection input of a selectable item in the view, and if the selection input is of a pre-determined type, generate a menu that includes functions that operate on the selected item.

13. The apparatus of claim 12 further comprising that:
when the selection input of the title bar is of the pre-determined type, the processor is configured to group all application functions that operate with the contacts application view and present the functions in the menu; and
when the selection input on a selectable item is of the pre-determined type, identify all functions that operate on the selectable item and present the functions in the menu.

14. The apparatus of claim 13 further comprising that the processor is configured to detect as short tap on the title bar as the selection input and generate the menu and a long tap on the selected item as the selection input and generate the menu.

15. A user interface for a contacts application comprising:
a display for a view related to the contacts application, the display including:
a first region that includes a title bar of the contacts application view, the title bar configured to be selectable, and a detection of a pre-determined input to the title bar will generate a menu on the view that includes functions specific to the contacts application;
at least a second region that includes items specific to the contacts applications view, wherein a selection input of a pre-determined type to an item will generate a menu on the view that includes functions specific to the item.

16. The user interface of claim 15 a pop-up window on the view that includes the generated menu.

17. The user interface of claim 15 further comprising that the menu for an item specific to the contacts application includes data related to the item.

18. A computer program product comprising computer program readable code means stored in a memory, the computer readable program code means configured to execute the method steps of claim 1.
